(19) United States
(12) Patent Application Publication
(10) Pub. No.: US 2022/0333505 A1
(43) Pub. Date: Oct. 20, 2022

(54) ROLLER HYDRAULIC VALVE LIFTER BEARING

(71) Applicant: Roller Bearing Company of America, Inc., Oxford, CT (US)

(72) Inventors: Kelvin M. Smith, New Hartford, CT (US); Eric Smooke, Woodbridge, CT (US)

(73) Assignee: Roller Bearing Company of America, Inc., Oxford, CT (US)

(21) Appl. No.: 17/854,088

(22) Filed: Jun. 30, 2022

Related U.S. Application Data
(63) Continuation of application No. 16/142,157, filed on Sep. 26, 2018.
(60) Provisional application No. 62/563,958, filed on Sep. 27, 2017.

(51) Int. Cl. F01L 1/14; F16C 33/34; F01L 1/18; F01L 1/24; F16C 13/00; F01L 1/047; F16C 19/26

(52) U.S. Cl. CPC F01L 1/14; F16C 33/34; F01L 1/181; F01L 1/24; F16C 13/006; F01L 1/047; F16C 19/26; F16C 2202/04; F16C 2223/16; F01L 2001/2427; F16C 33/62

(57) ABSTRACT

A roller hydraulic valve lifter includes a body having a longitudinal central axis and an interior area defined by an inside surface which has a pair of flat surfaces opposite one another and connected by a pair of walls. A first bore, essentially perpendicular to the longitudinal axis, extends through the flat surfaces. A bearing is disposed partially in the interior area. The bearing includes an outer ring having substantially cylindrical exterior and interior bearing surfaces. A shaft extends through the first bore and the outer ring and between the pair of flat surfaces. A plurality of needle rollers is disposed between and rollingly engage the shaft and the cylindrical inner bearing surface. The shaft and the plurality of needle rollers are manufactured from an AISI 52100 alloy steel that is carbo-nitrided. The shaft and the plurality of needle rollers have a surface hardness of a minimum of HRc 65.

### CROSS REFERENCE TO RELATED APPLICATION

This application is a continuation of and claims priority benefit to U.S. Nonprovisional patent application Ser. No. 16/142,157, filed on Sep. 26, 2018, which claims the benefit of U.S. Provisional Application No. 62/563,958, entitled “Roller Hydraulic Valve Lifter Bearing”, filed on Sep. 27, 2017, the entirety of which is incorporated by reference herein.

### TECHNICAL FIELD

The present invention relates generally to a roller hydraulic valve lifter bearing with improved life, and more particularly to roller hydraulic lifter bearing having a plurality of needle rollers and a shaft that are manufactured from an AISI 52100 alloy steel that is carbo-nitrided to a minimum HRc 65, to increase the life thereof by at least 1.5 times the life of a roller hydraulic lifter bearing having a plurality of needle rollers and a shaft that are manufactured from an AISI 52100 alloy steel, with a surface hardness of less than HRc 65 and without such carbo-nitriding.

### BACKGROUND

A shown in FIG. 1, a prior art cam-in-block engine valvetrain (also referred to as pushrod type engine valvetrain) is generally designated by the numeral 100. The cam-in-block engine valvetrain 100 has a rocker arm 101 that pivots on a shaft 102 mounted to the engine block (not shown). A push rod 103 is pivotally coupled to one side of the rocker arm 101. A hydraulic piston 104 is connected to a distal end of the push rod 103. The cam-in-block engine valvetrain 100 includes a roller hydraulic valve lifter 105 that is disposed in a bore in the engine block. The roller hydraulic valve lifter 105 has an interior area in which a portion of the hydraulic piston is slidingly disposed. The roller hydraulic valve lifter 105 includes a bearing 109 that is rotatably mounted to a shaft 111 that extends through and is secured to the roller hydraulic valve lifter 105. A plurality of needle rollers (not shown) are disposed between the bearing 109 and the shaft 111. A portion of the bearing 109 (e.g., the outer ring) extends out of the roller hydraulic valve lifter 105. An exterior surface 109E of the bearing 109 rollingly engages a cam 106. Typically, prior art roller hydraulic valve lifters 105 have the shaft 111 and the needle rollers in the bearing 109 manufactured from an AISI 52100 alloy steel with a surface hardness of less than HRc 65.

Rotation of the cam 106 causes rotation of the bearing 109 (e.g., the outer ring) and causes the roller hydraulic valve lifter 105, the bearing 109, the hydraulic piston 104, and the pushrod 103 to oscillate in the direction of the arrow K. Design life of the cam-in-block engine valvetrain can require the bearing 109 to withstand well over one hundred million revolutions. However, the needle rollers and shaft of prior art bearings 109 and shafts 111 tend to fail prematurely in some applications.

Those skilled in the relevant art understand that increasing the size (i.e., outside diameter) of the shaft 111 and/or the size (i.e., axial length and/or outside diameter) of the needle rollers would increase life (i.e., reduce contact pressure) on the shaft and the needle rollers. However, increasing the size of the shaft 111 and/or the needle rollers could require the outer ring of the bearing 109 to be thinner, which can make the outer ring more susceptible to failure. In addition, lengthening the needle rollers or making the outer ring larger to accommodate a larger shaft and needle rollers would require that the roller hydraulic valve lifter 105 be made larger. Making the roller hydraulic valve lifter 105 larger would require redesign of the valve train and/or engine block.

Heat treatment and surface diffusion processing of metallic materials can increase the surface hardness of such materials. However, such heat treatment and surface diffusion has been discouraged because of the prohibitive cost and manufacturing time. Those skilled in the relevant art would understand that the cost of heat treatment and surface diffusion increases exponentially with increasing case depth. Moreover, there are many combinations of roller hydraulic valve lifter 105 components to target improvement on for increase in life. Selection of the appropriate component and type of improvement technology typically requires extensive analysis and testing. A solution for improving the life of roller hydraulic valve lifters 105 has evaded those skilled in the art for many years.

As shown in FIG. 8, U.S. Pat. No. 9,267,538, “Rolling Sliding Parts” discloses a heat treatment process that includes a carbo-nitriding step, followed by a first quench, followed by heating above the austenitizing temperature (e.g., about 800° C.) followed by a second quench. In particular, the process includes heating to 845° C., cooling below A1, heating again to 800° C. and quenching.

Based on the foregoing, there is a need to provide a roller hydraulic valve lifter that is less expensive and retains greater dimensional stability compared to the prior art roller hydraulic valve lifter.

### SUMMARY

There is disclosed herein a roller hydraulic valve lifter that includes a body that has a longitudinal central axis and an interior area defined by an inside surface. The inside surface includes a first flat surface and a second flat surface, opposite the first flat surface. The first flat surface and the second flat surface being connected by a pair of connecting walls, a first bore extending through the first flat surface and the second flat surface, the first bore being substantially perpendicular to the longitudinal axis. The roller hydraulic valve lifter includes a bearing disposed partially in the interior area. The bearing includes an outer ring that has a substantially cylindrical exterior bearing surface and a substantially cylindrical inner bearing surface that defines a second bore. The roller hydraulic valve lifter includes a shaft that extends through the first bore and the second bore. The shaft extends between the first flat surface and the second flat surface. A plurality of needle rollers is disposed between and rollingly engage the shaft and the cylindrical inner bearing surface. The shaft and the plurality of needle rollers are manufactured from an AISI 52100 alloy steel that is carbo-nitrided. The shaft and the plurality of rollers each have a surface hardness of a minimum of HRc 65.

In one embodiment, the shaft and the plurality of needle rollers each have a minimum carbo-nitrided case depth of 0.25 mm. In one embodiment, the shaft and plurality of needle rollers each have a minimum carbo-nitrided case depth of between 0.010 inches to 0.020 inches (0.25 mm to 0.51 mm). In one embodiment, the shaft and the plurality of needle rollers each have an exterior surface that is in compression. In one embodiment, the exterior surface is treated by a mass finishing process to enhance the surface compression. In one embodiment, the shaft and the plurality of needle rollers each have a core hardness of HRc 59 to HRc 65.

There is further disclosed herein a method of increasing the life of a roller hydraulic valve lifter. The method includes providing a first roller hydraulic valve lifter that has a body which has a predetermined set of dimensions and a first shaft mounted in the body. The first shaft has a first outside diameter. The first roller hydraulic valve lifter includes a first bearing that has an outer ring which has a second outside diameter, a first inside diameter and an axial length. The first roller hydraulic valve lifter includes a plurality of first needle rollers each having a third outside diameter and an axial length. The plurality of first needle rollers is disposed between and in rolling engagement with the first shaft and the outer ring. The first shaft and the plurality of first needle rollers are manufactured from an AISI 52100 alloy steel having a surface hardness of less than HRc 65.

The method includes creating a second roller hydraulic valve lifter that has a life of at least 1.5 times that of the first roller hydraulic valve lifter. The second roller hydraulic valve lifter is created by substituting the first shaft and the plurality of first needle rollers with a second shaft and a plurality of second needle rollers. The second shaft has the first outside diameter and the plurality of second needle rollers each having the third outside diameter and the axial length, of the same magnitudes of the respective first shaft and plurality of first needle rollers. The method includes utilizing the body of the first roller hydraulic valve lifter, without changing any of the dimensions of the body. The method includes utilizing the outer ring having the second outside diameter, the first inside diameter and the axial length, of the same respective dimensions of the outer ring of the bearing of the first roller hydraulic valve lifter. The plurality of second needle rollers being is disposed between and in rolling engagement with the second shaft and the outer ring. The second shaft and the plurality of the second rollers are manufactured from an AISI 52100 alloy steel that is carbo-nitrided. The second shaft and the plurality of second needle rollers each have a surface hardness of a minimum of HRc 65.

In one embodiment, the second shaft and the plurality of second needle rollers each have a minimum carbo-nitrided case depth of 0.25 mm. In one embodiment, the second shaft and the plurality of second needle rollers each have an exterior surface that is in compression. In one embodiment, the exterior surface is treated by a mass finishing process. In one embodiment, the second shaft and the plurality of second needle rollers each have a core hardness of HRc 59 to HRc 65.

There is further disclosed herein a method for manufacturing (e.g., heat treating) a shaft and rollers for a roller hydraulic valve lifter. The method includes the following steps in the order presented: providing an AISI 52100 alloy steel; carbonitriding the AISI 52100 alloy steel; oil quenching the AISI 52100 alloy steel; tempering the AISI 52100 alloy steel at 149° C.; and cooling the AISI 52100 alloy steel to −84° C.

In one embodiment, another tempering step is performed at 177° C. after the cooling.

In one embodiment, the carbonitriding is performed at 829° C.

### BRIEF DESCRIPTION OF THE DRAWINGS

FIG. 1 is a schematic view of a cam-in-block engine valvetrain with a prior art roller hydraulic valve lifter;

FIG. 2 is a perspective view of the roller hydraulic valve lifter of the present invention;

FIG. 3 is a perspective view of a bearing for the roller hydraulic valve lifter of FIG. 2 shown with a temporary plug therein for retaining the needle rollers therein prior to installation in a roller hydraulic valve lifter;

FIG. 4 is a perspective view of the shaft of the roller hydraulic valve lifter of FIG. 2;

FIG. 5 is a cross sectional view of the roller hydraulic valve lifter of FIG. 2 taken across section 5-5;

FIG. 6 is a bottom view of the roller hydraulic valve lifter of FIG. 2;

FIG. 7 is a cross sectional view of the roller hydraulic valve lifter of FIG. 2 taken across section 7-7;

FIG. 8 is a graph of a prior art carbo-nitriding heat treatment process; and

FIG. 9 is a graph of a carbo-nitriding heat treatment process of the present invention.

### DETAILED DESCRIPTION

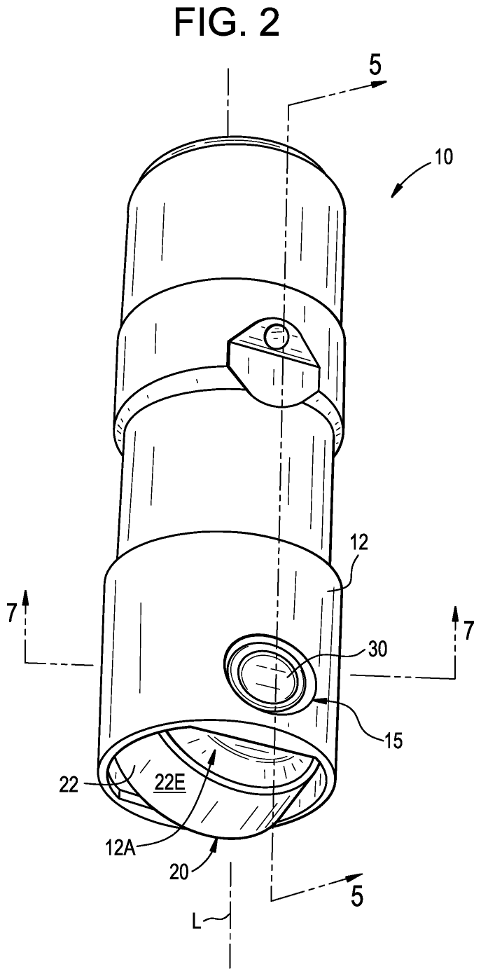

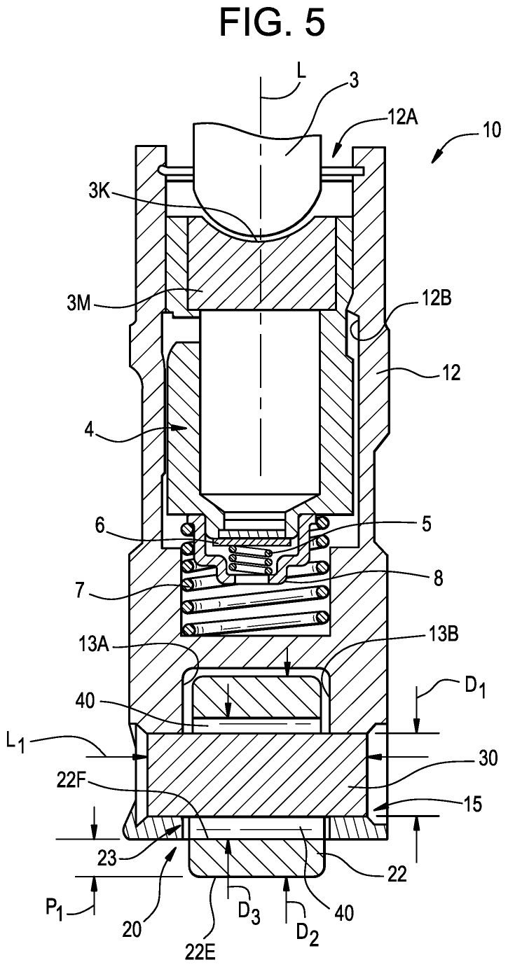

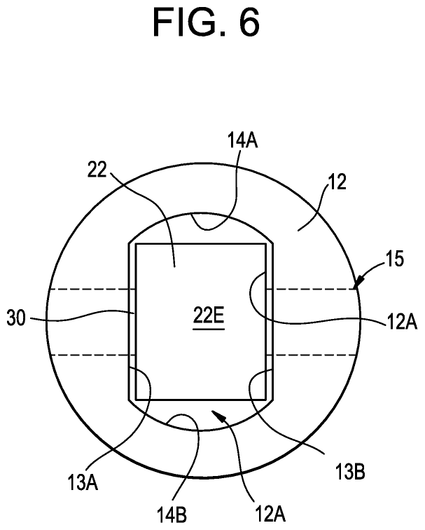

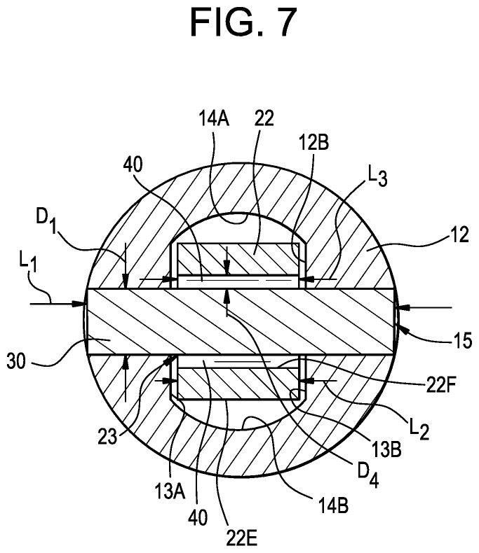

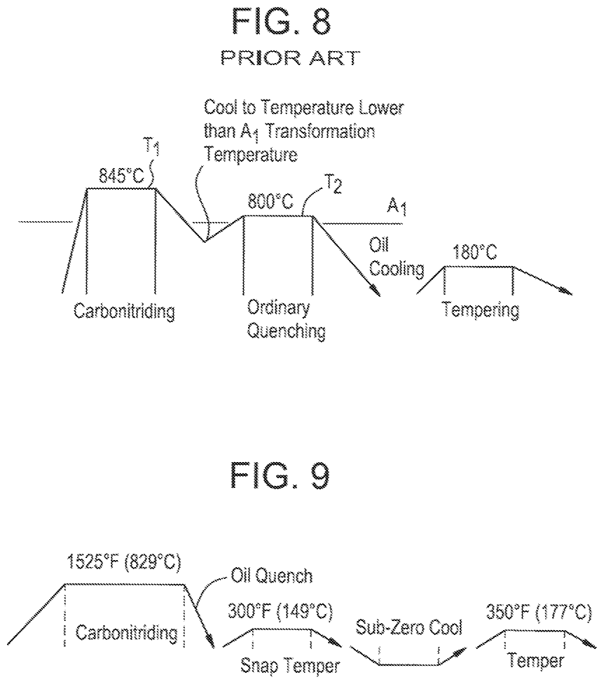

As shown in FIG. 2, a roller hydraulic valve lifter of the present invention is generally designated by the numeral 10. As shown in FIGS. 2 and 5, the roller hydraulic valve lifter 10 includes a generally cylindrical body 12 having a longitudinal central axis L. The body 12 has an interior area 12A defined by an inside surface 12B (see FIG. 5). As shown in FIGS. 5-7, the inside surface 12B includes a first flat surface 13A and a second flat surface 13B opposite the first flat surface 13A. The first flat surface 13A and the second flat surface 13B are connected by a pair of connecting walls 14A and 14B (see FIGS. 6 and 7). In one embodiment, the connecting walls 14A and 14B are arcuate (e.g., a section of a cylinder). A first bore 15 extends through the first flat surface 13A and the second flat surface 13B and entirely through the body 12. The first bore 15 is substantially perpendicular to the longitudinal axis L.

As shown in FIGS. 2, 3 and 5-7 the roller hydraulic valve lifter 10 includes a bearing 20 disposed partially in the interior area 12A. Thus, a portion of the bearing 20 extends axially out of the interior area 12A of the roller hydraulic valve lifter 10 by a distance P1, as shown in FIG. 5. The bearing 20 includes an outer ring 22 that has a substantially cylindrical exterior bearing surface 22E and a substantially cylindrical inner bearing surface 22F that defines a second bore 23. The exterior bearing surface 22E defines an outside diameter D2 and the inner bearing surface 22F defines an inside diameter D3, as shown in FIG. 5. The outer ring 22 has an axial length L2 (depicted in FIG. 7).

As shown in FIG. 5, the hydraulic piston 4 engages a pushrod seat 3K of a pushrod 3 that extends into the interior area 12A. The hydraulic piston 4 is a damper that absorbs shock and takes up clearance between all of the components of the valve train to reduce clatter and other noise. An inner biasing member 5 holds valve 6 in place against one end of the piston 4. The inner biasing member 5 and valve 6 sit within damper cup 8, which is held against the piston 4 by outer biasing member 7. In other embodiments, the valve 6 is a ball valve or a check valve with a different structure.

As shown in FIGS. 2 and 4-7, a shaft 30 extends through the first bore 15 and the second bore 23. The shaft 30 extends through the first bore 15 a length L1 and between the first flat surface 13A and the second flat surface 13B. The shaft 30 is substantially cylindrical and has an outside diameter D1.

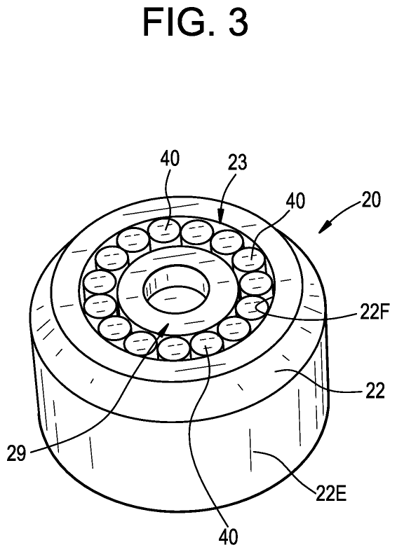

As shown in FIGS. 3, 4, 5 and 7, a plurality of needle rollers 40 are disposed between and rollingly engage an exterior surface 30E of the shaft 30 and the cylindrical inner bearing surface 22F. Each of the plurality of needle rollers 40 is substantially cylindrical and has an axial length L3. Prior to installation of the bearing 20 in the roller hydraulic valve lifter 10, the plurality of needle rollers 40 are temporarily held in position by a plug 29 (e.g., a plastic plug), as shown in FIG. 3. During installation of the bearing 20 in the roller hydraulic valve lifter 10, the shaft 30 is pressed through the bore 15 to displace the plug 29 and hold the plurality of needle rollers 40 in position around the shaft 30. The shaft 30 pushes the plug 29 out of the bore 15. The plurality of needle rollers 40 rollingly engage a portion of the shaft 30 along a length of the shaft about equal to the length L3 of the needle rollers, between the first flat surface 13A and the second flat surface 13B. The plurality of needle rollers 40 are retained axially by and maintain an axial position between the first flat surface 13A and the second flat surface 13B

The shaft 30 and the plurality of needle rollers 40 are manufactured from an AISI 52100 alloy steel that is carbo-nitrided such that the shaft 30 and the plurality of needle rollers 40 each have a surface hardness of a minimum of HRc 65. In one embodiment, the shaft 30 has a surface hardness of HRc 65 to HRc 69. In one embodiment, the plurality of rollers 40 each has a surface hardness of HRc 65 to HRc 69. The shaft 30 and the plurality of needle rollers 40 each have a minimum carbo-nitrided case depth of 0.25 mm. In one embodiment, the shaft 30 and the plurality of needle rollers 40 each have a case depth of 0.25 mm to 0.50 mm.

The shaft 30 and each of the plurality of needle rollers 40 each have an exterior surface that is in compression (e.g., has a residual compressive stress). In one embodiment, the exterior surface is treated by a mass finishing process (e.g., barrel finishing, vibratory finishing, tumbling, or the like to help obtain the compression of the exterior surface. In one embodiment, the shaft 30 and each of the plurality of needle rollers 40 each have a core hardness of HRc 59 to HRc 65.

AISI 52100 is also referred to as GCr15, SUJ2 and 100Cr6 which are the Chinese, Japanese and German versions, respectively and has the following chemical composition, wherein the percentages are given in weight percent.

| | Chemical Compoisition % | | | | | | | | |
|---|---|---|---|---|---|---|---|---|---|
| | C | Mn | P | S | Si | Ni | Cr | Cu | Mo |
| Steel | 0.93-1.10 | 0.500 | 0.030 | 0.025 | 0.15-0.35 | 0.300 | 1.30-1.65 | 0.300 | 0.100 |
| | | Max | Max | Max | | Max | | Max | Max |

The shaft 30 and each of the plurality of needle rollers 40 each have an exterior surface that is in compression, for example, a compressed surface treatment created by a mass finishing process. The shaft 30 and each of the plurality of needle rollers 40 each have a microstructure that has less than 12 percent by volume retained austenite for improved dimensional stability, higher hardness (i.e., greater than HRc 65) and improved wear resistance.

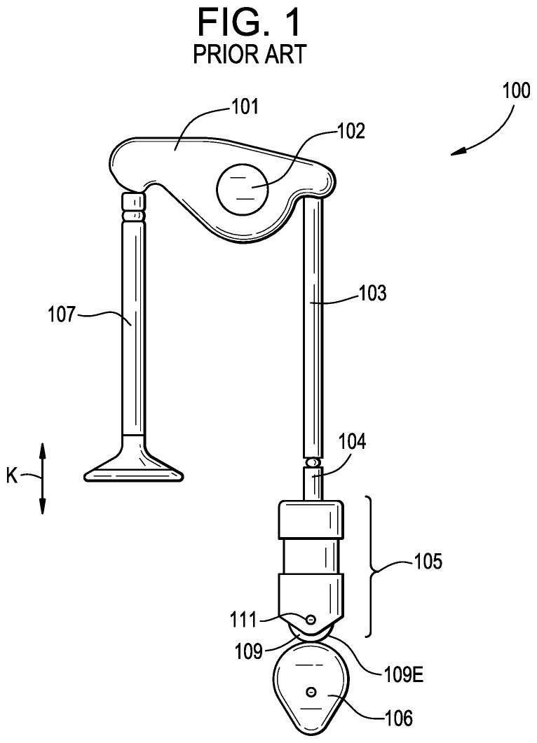

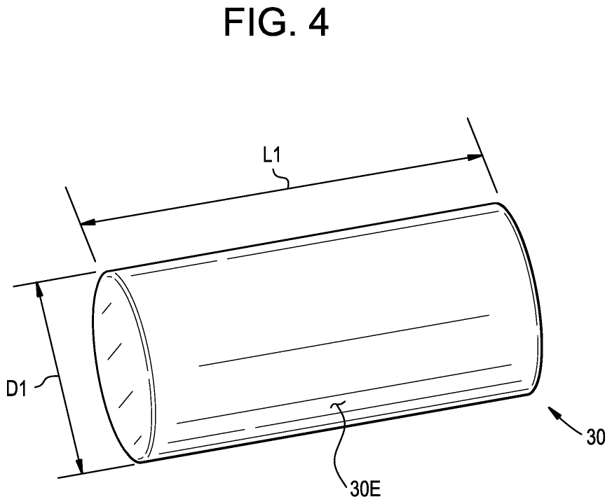

There is also disclosed herein a method of increasing the life of a prior art roller hydraulic valve lifter 105, as illustrated in FIG. 1. The method includes providing a first roller hydraulic valve lifter 105 that includes the body having a predetermined set of dimensions (e.g., outside diameter of the body, clearances between the exterior surface of the bearing 109 and the interior area of the body; clearances between the axial ends of the needle rollers and interior area of the body; and clearances between the axial ends of the bearing 109 and the interior area of the body). The method also includes providing a first shaft 111 mounted in the body. The first shaft 111 has a first outside diameter D1, dimensionally similar to that shown in FIG. 4 for the second shaft 30. The roller hydraulic valve lifter 105 includes a first bearing 109 that has an outer ring which has a second outside diameter D2, a first inside diameter D3 and an axial length L2, dimensionally similar to that shown in FIGS. 5 and 7 for the second bearing 20. The roller hydraulic valve lifter 105 includes a plurality of first needle rollers each having a third outside diameter D4 and an axial length L3, dimensionally similar to that shown in FIG. 7 for the plurality of second needle rollers 40. The plurality of first needle rollers is disposed between and in rolling engagement with the first shaft 111 and the outer ring of the first bearing 109. The first shaft 111 and the plurality of first needle rollers are manufactured from an AISI 52100 alloy steel and have a surface hardness of less than HRc 65.

The method includes creating a second roller hydraulic valve lifter 10 (e.g., by retrofitting the first roller hydraulic valve lifter 105) that has a life of at least 1.5 times that of the first roller hydraulic valve lifter 105. The second roller hydraulic valve lifter 10 is created by substituting the first shaft 111 and the plurality of first needle rollers in the first roller hydraulic valve lifter 105, with a second shaft 30 and a plurality of second needle rollers 40. The second shaft 30 has essentially the same dimension as the first shaft 111 of the first roller hydraulic valve lifter 105. For example, the first and second shafts 111 and 30 both have first outside diameters D1 of the same magnitude. The plurality of second needle rollers 40 each has essentially the same dimensions as the plurality of needle rollers of the first roller hydraulic valve lifter 105. For example, each of the plurality of second needle rollers 40 has a third outside diameter D4 and an axial length L3 of a same magnitude as the plurality of first needle rollers of the first roller hydraulic valve lifter 105. The method includes utilizing the body 12 having the predetermined set of dimensions essentially the same as the body of the first roller hydraulic valve lifter 105. The method also includes utilizing the outer ring 22 having a second outside diameter D2, a first inside diameter D3 and an axial length L2 of essentially the same magnitude compared to the respective dimensions of the outer ring of the bearing 109 of the first roller hydraulic valve lifter 105. The plurality of second needle rollers 40 is disposed between and in rolling engagement with the second shaft 30 and the outer ring 22. The second shaft 30 and the plurality of the second needle rollers 40 are manufactured from an AISI 52100 alloy steel that is carbo-nitrided. The second shaft 30 and plurality of second needle rollers 40 have a surface hardness of a minimum of HRc 65.

In one embodiment, the second shaft 30 and the plurality of second needle rollers 40 each have a minimum carbo-nitrided case depth of 0.25 mm. In one embodiment, the second shaft 30 and the plurality of second needle rollers 40 each have an exterior surface that is in compression. In one embodiment, the exterior surface is treated by a mass finishing process to help enhance the surface compression. In one embodiment, the second shaft 30 and the plurality of second needle rollers 40 each have a core hardness of HRc 59 to HRc 65.

There is also disclosed herein a method for manufacturing (e.g., heat treating, per FIG. 9) the shaft 30 and rollers 40 for a roller hydraulic valve lifter 10 of the present invention. The method includes the following steps in the order presented. An AISI 52100 alloy steel is provided. Step 1—carbonitriding the AISI 52100 alloy steel; Step 2—oil quenching the AISI 52100 alloy steel; Step 3—tempering the AISI 52100 alloy steel at 149° C.; and Step 4—cooling the AISI 52100 alloy steel to −84° C. In one embodiment, the method includes Step 5—another tempering step that is performed at 177° C. after the cooling.

Carbo-nitriding, as used herein refers to heating the parts (e.g., the shaft 30 and the plurality of needle rollers 40) to an austenitizing temperature in a nitrogen rich atmosphere. For example, the gas concentrations in the furnace atmosphere are 0.85%+/−0.05% carbon and 3.00% ammonia+/−0.15 m³ per hour ammonia flow rate. As shown in FIG. 9, a heat treatment process (i.e., for an AISI 52100 alloy steel) of the present invention is shown. The heat treatment process includes carbo-nitriding (Step 1) the shaft 30 and the plurality of needle rollers 40 that are manufactured from AISI alloy steel by heating in a furnace at 1525° F.+/−25° F. (829° C.) in an atmosphere of 0.85%+/−0.05% carbon and 3.00% ammonia+/−0.15 m³ per hour ammonia flow rate. After Step 1, the shaft 30 and the plurality of needle rollers 40 are oil quenched (Step 2) to ambient temperature. After Step 2, the shaft 30 and the plurality of needle rollers 40 are tempered (Step 3) for example, snap tempered at 300° F.+/−10° F. (149° C.). After Step 3, the shaft 30 and the plurality of needle rollers 40 are cooled (Step 4) to −120° F.+/−10° F. (−84° C.). The temperature for step 4 is chosen to balance the cost against the reduction in retained austenite. In one embodiment, after Step 4, the shaft 30 and the plurality of needle rollers 40 are tempered (Step 5) at 350° F.+/−15° F. (177° C.). As shown in FIG. 9, the shaft 30 and the plurality of needle rollers 40 are not heated or tempered between Step 1 and Step 2. As shown in FIG. 9, the heat treatment process includes only one quenching step, namely Step 2. The term quenching, as used herein means, the rapid cooling of a workpiece in water, oil or air to obtain certain material properties. Quenching prevents undesired low-temperature processes, such as phase transformations, from occurring. The snap temper referred to in Step 3 is used to stress relieve the part prior to sub-zero cooling. During quenching or rapid cooling, stresses are induced in the steel. Cooling to −120° F. directly after quenching adds more stress and can potentially lead to cracking. The snap temper step relieves some of the internal stresses from quenching, reducing the chance of cracking during sub-zero cooling. The heat treatment process results in the shaft 30 and each of the plurality of needle rollers 40 each having a microstructure that has less than 12 percent by volume retained austenite for improved dimensional stability, higher hardness (i.e., greater than HRc 65) and improved wear resistance. The part is less dimensionally stable with more retained austenite. Austenite can change to martensite under stress and temperature changes. Martensite occupies more volume than austenite so the part can grow in volume. Typically, not all the austenite changes to martensite so the actual growth is difficult to predict; however, it does not take much change in volume to reduce the clearance in the bearings if both the shaft and needles are heat treated with this process. Additionally, excessive retained austenite can reduce the surface hardness. Austenite is a softer constituent than martensite or carbides and nitrides that are present. The process is designed to obtain the hardest surface to reduce wear and increase bearing life without being prohibitively expensive.

### Example 1

Over ten load tests of the roller hydraulic valve lifter bearings 20 of the present invention with the shaft 30 and the plurality of needle rollers 40 manufactured from an AISI 52100 alloy steel that is carbo-nitrided; and the shaft and the plurality of rollers each having a surface hardness of a minimum of HRc 65, with high loads and speeds have been run. On average, the roller hydraulic valve lifter bearings 20 did not fail until over 4.8 million revolutions. Whereas, on average, for tests with the same high loads and speeds, the prior art roller hydraulic valve lifter bearings of the prior art roller hydraulic valve lifters 105 with the first shaft and the plurality of first needle rollers manufactured from an AISI 52100 alloy steel having a surface hardness of less than HRc 65 failed at 2.9 million revolutions. Thus, the roller hydraulic valve lifter bearings 20 of the present invention had an increased life of 1.68 times greater than the life of the prior art roller hydraulic valve lifter bearings.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A roller hydraulic valve lifter comprising:
a body having a longitudinal central axis and an interior area defined by an inside surface, the inside surface comprising a first flat surface and a second flat surface opposite the first flat surface, the first flat surface and the second flat surface being connected by a pair of connecting walls, a first bore extending through the first flat surface and the second flat surface, the first bore being substantially perpendicular to the longitudinal central axis; and
a bearing disposed partially in the interior area, the bearing comprising:
an outer ring having a substantially cylindrical exterior bearing surface, and a substantially cylindrical inner bearing surface that defines a second bore;
a shaft extending through the first bore and the second bore, the shaft extending between the first flat surface and the second flat surface; and
a plurality of needle rollers disposed between and rollingly engaging the shaft and the substantially cylindrical inner bearing surface,
wherein the shaft and the plurality of needle rollers are manufactured from an AISI 52100 alloy steel that is thermochemically treated according to the follow steps in the order presented resulting in a surface hardness of a minimum of HRc 65 for the shaft and the plurality of needle rollers:
carbo-nitriding;
oil quenching after the carbo-nitriding;
a first tempering at 149° C. after the oil quenching;
cooling to −84° C. after the first tempering; and
a second tempering at 177° C. after the cooling to −84° C.

2. The roller hydraulic valve lifter of claim 1, wherein the shaft and the plurality of needle rollers each have a minimum carbo-nitrided case depth of 0.25 mm.

3. The roller hydraulic valve lifter of claim 1, wherein the shaft and the plurality of needle rollers each have a core hardness of HRc 59 to HRc 65.

4. The roller hydraulic valve lifter of claim 1, wherein the shaft and the plurality of needle rollers each have an exterior surface that is in compression.

5. The roller hydraulic valve lifter of claim 4, wherein the exterior surfaces of the shaft and the plurality of needle rollers are treated by a mass finishing process.

6. The roller hydraulic valve lifter of claim 1, wherein the shaft and the plurality of needle rollers each have a microstructure having less than 12 volumetric percent retained austenite.

7. The roller hydraulic valve lifter of claim 1, wherein the bearing is configured to withstand 4.8 million revolutions.

8. The roller hydraulic valve lifter of claim 1, further comprising:
a valve;
a hydraulic piston disposed inside the body; and
an inner biasing member configured to hold the valve against an end of the hydraulic piston.

9. The roller hydraulic valve lifter of claim 8, further comprising:
a damper cup; and
an outer biasing member configured to hold the damper cup against the hydraulic piston,
wherein the inner biasing member and the valve sit within the damper cup.

10. A method of thermochemically treating one or more bearing components, the method comprising:
carbo-nitriding the one or more bearing components;
oil quenching the one or more bearing components after the carbo-nitriding;
subjecting the one or more bearing components to a first tempering at 149° C. after the oil quenching;
cooling the one or more bearing components to −84° C. after the first tempering; and
subjecting the one or more bearing components to a second tempering at 177° C. after the cooling to −84.

11. The method of claim 10, wherein the one or more bearing components comprise a shaft of a roller hydraulic valve lifter and a plurality of needle rollers of the roller hydraulic valve lifter, wherein the roller hydraulic valve lifter comprises:
a body having a longitudinal central axis and an interior area defined by an inside surface, the inside surface comprising a first flat surface and a second flat surface opposite the first flat surface, the first flat surface and the second flat surface being connected by a pair of connecting walls, a first bore extending through the first flat surface and the second flat surface, the first bore being substantially perpendicular to the longitudinal central axis; and
a bearing disposed partially in the interior area, the bearing comprising an outer ring having a substantially cylindrical exterior bearing surface, and a substantially cylindrical inner bearing surface that defines a second bore,
wherein the shaft extends through the first bore and the second bore, and extends between the first flat surface and the second flat surface,
wherein the plurality of needle rollers is disposed between and rollingly engages the shaft and the substantially cylindrical inner bearing surface, and
wherein the shaft and the plurality of needle rollers are manufactured from an AISI 52100 alloy steel and have a surface hardness of a minimum of HRc 65.

12. The method of claim 10, wherein the one or more bearing components are manufactured from an AISI 52100 alloy steel.

13. The method of claim 10, wherein the method results in the one or more bearing components having a minimum surface hardness of HRc 65.

14. The method of claim 10, wherein the one or more bearing components comprise a shaft.

15. The method of claim 10, wherein the one or more bearing components comprise a needle roller.

16. A method of increasing a life of a roller hydraulic valve lifter, the method comprising:
providing a roller hydraulic valve lifter comprising a body, an outer ring, a first shaft mounted in the body, and first needle rollers disposed between and in rolling engagement with the first shaft and the outer ring, the first shaft and the first needle rollers having a surface hardness of less than HRc 65;
thermochemically treating a second shaft and second needle rollers according to the following steps, thereby establishing a surface hardness of a minimum of HRc 65 of the second shaft and the second needle rollers:
carbo-nitriding;
oil quenching after the carbo-nitriding;
a first tempering at 149° C. after the oil quenching;
cooling to −84° C. after the first tempering; and
a second tempering at 177° C. after the cooling to −84° C.;
replacing the first shaft with the second shaft; and
replacing the first needle rollers with the second needle rollers.

17. The method of claim 16, wherein the first shaft and the first needle rollers are manufactured from an AISI 52100 alloy steel.

18. The method of claim 16, wherein a diameter of the first shaft is the same as a diameter of the second shaft, and an axial length of the first shaft is the same as an axial length of the second shaft.

19. The method of claim 16, wherein a diameter of each of the first needle rollers is the same as a diameter of each of the second needle rollers, and an axial length of each of the first needle rollers is the same as an axial length of each of the second needle rollers.

20. The method of claim 16, wherein after the replacing of the first shaft with the second shaft and after the replacing of the first needle rollers with the second needle rollers, the second needle rollers are disposed between and in rolling engagement with the second shaft and the outer ring.

21. The method of claim 16, wherein the second shaft and the second rollers are manufactured from an AISI 52100 alloy steel.
